(19) United States
(12) Patent Application Publication
(10) Pub. No.: US 2011/0206521 A1
(43) Pub. Date: Aug. 25, 2011

(54) Rotating Part Assembly for Motor

(76) Inventors: Alex Horng, Kaohsiung (TW); Hung-Jen Chuang, Kaohsiung (TW)

(21) Appl. No.: 12/710,392

(22) Filed: Feb. 23, 2010

(51) Int. Cl. F16C 35/08

(52) U.S. Cl. 416/204 R; 464/184

(57) ABSTRACT

A rotating part assembly for motor is presented, which includes a hub, a shaft, and a holding member. The hub has an assembly channel with a first end and a second end, with a first abutting portion encircling and defining the first end and a second abutting portion encircling and defining the second end, with a first positioning portion arranged between the first end and the second end of the assembly channel. The shaft extends through the assembly channel of the hub and provides a first end section and a second end section, wherein an engaging slit aligning with the first abutting portion, an engaging shoulder aligning with the second abutting portion, and a second positioning portion facing the first positioning portion are disposed at the first end section. The holding member inserts into and couples with the engaging slit and abuts the first abutting portion of the hub.

### BACKGROUND OF THE INVENTION

1. Field of the Invention

The present invention relates to a rotating part assembly, particularly to a rotating part assembly for motor.

2. Description of the Related Art

Referring to FIG. 1, a conventional motor structure is shown. The motor structure comprises a motor 8 including a base 81, a stator 82 and a rotor 83. The base 81 couples with a shaft tube 811, with the stator 82 mounted on the shaft tube 811. The rotor 83 includes a hub 831, a shaft 832, and a permanent magnet 833. The hub 831 couples with an end of the shaft 832 by injection molding, while the other end of the shaft 832 rotatably couples with and extends into the shaft tube 811. The permanent magnet 833 is mounted on an inner surface of the hub 831. With the above-described structure, the rotor 83 is actuated to rotate while the stator 82 is electrified to generate an alternative magnetic field. Specifically, a motor of similar structure like the motor 8 is usually called an “outer rotor motor,” which is assembled by having the shaft 832 of the rotor 83 extend into the shaft tube 811 following the assembly of the base 81 and the stator 82. Thus, for convenience in manufacture, the rotor 83 should be completely constructed before the shaft 832 is coupled with the shaft tube 811.

However, some motors commonly and currently used can not be assembled via the said steps. That is, in some situation, the manufacturer can not mount the hub 831 onto the shaft 832 before the shaft is rotatably coupled with a bearing received in the shaft tube 811. For example, another conventional motor 9 including a base 91, a stator 92, a shaft 93, and a rotating unit 94, which should be assembled in different steps, is shown. The base 91 also has a shaft tube 911 on the top thereof. The stator 92 and shaft 93 are coupled with the base 91 in advance, with the shaft 93 rotatably extending into the shaft tube 911, as well as a free end of the shaft 93 forming a thread portion 931 outside the shaft tube 911. Finally, a hub 941 of the rotating unit 94 is screwed on the free end of the shaft 93 through the thread portion 931.

A drawback of the conventional motor 9 is that a stable engagement between the hub 941 and the thread portion 931 of the shaft 93 is necessary and is only achieved in the said screw way, which can be easily loosed due to external force, and a loose engagement between the hub 941 and the thread portion 931 may affect rotation of the rotating unit 94. Besides, rotation of the rotating unit 94 with change in acceleration when the motor 9 is started, speeded, decelerated, or stopped also affects the screwing engagement between the hub 941 and the shaft 93. Hence, there is a need to improve the conventional motor structure.

### SUMMARY OF THE INVENTION

It is the primary objective of this invention to provide a rotating part assembly for motor that efficiently prevents a hub from disengaging from a shaft.

It is the secondary objective of this invention to provide a rotating part assembly for motor with firmly combination in both of axial and radial directions.

The rotating part assembly for motor in accordance with an aspect of the present invention comprises a hub, a shaft, and a holding member. The hub has an assembly channel with a first end and a second end, with a first abutting portion encircling and defining the first end and a second abutting portion encircling and defining the second end, with a first positioning portion arranged between the first end and the second end of the assembly channel. The shaft extends through the assembly channel of the hub, engages with the assembly channel via a first end section, and extends out of the assembly channel from the second end to form a second end section, wherein an engaging slit aligning with the first abutting portion, an engaging shoulder aligning with the second abutting portion, and a second positioning portion facing the first positioning portion are disposed at the first end section. The holding member inserts into and couples with the engaging slit and abuts the first abutting portion of the hub. Consequently, stable and convenient assembly is achieved.

Further scope of the applicability of the present invention will become apparent from the detailed description given hereinafter. However, it should be understood that the detailed description and specific examples, while indicating preferable embodiments of the invention, are given by way of illustration only, since various will become apparent to those skilled in the art from this detailed description.

### BRIEF DESCRIPTION OF THE DRAWINGS

The present invention will become more fully understood from the detailed description given herein below and the accompanying drawings which are given by way of illustration only, and thus are not limitative of the present invention, and wherein:

FIG. 1 is a cross sectional side view of a conventional motor;

FIG. 2 is a cross sectional side view of another conventional motor;

FIG. 3 is an exploded perspective view of a rotating part assembly in accordance with a preferred embodiment of the present invention;

FIG. 4 is a cross sectional side view of the rotating part assembly in accordance with the present invention;

FIG. 5 is a cross sectional top view of the cooling module of FIG. 4 according to section line 5-5 of FIG. 4;

FIG. 6 is an exploded and cross sectional side view of a rotating part assembly within an inner rotor motor in accordance with the present invention;

FIG. 7 is a cross sectional view of the rotating part assembly within an inner rotor motor in accordance with the present invention;

FIG. 8 is an exploded perspective view of a rotating part assembly with an enhancing member in accordance with the present invention;

FIG. 9 is a cross sectional view of the rotating part assembly with an enhancing member in accordance with the present invention;

FIG. 10 is a perspective view of the enhancing member of the rotating part assembly in accordance with the present invention;

FIG. 11 is an exploded perspective view of a rotating part assembly with a first abutting portion having a protrusion and a holding member having an opening in accordance with the present invention;

FIG. 12 is a cross sectional view of the rotating part assembly with the first abutting portion having the protrusion and the holding member having the opening in accordance with the present invention;

FIG. 13 is an exploded perspective view of a rotating part assembly with a holding member in another form in accordance with the present invention;

FIG. 14 is a cross sectional view of the rotating part assembly with the holding member in another form in accordance with the present invention; and

FIG. 15 is a cross sectional view of a rotating part assembly with a hub having a plurality of blades in accordance with the present invention.

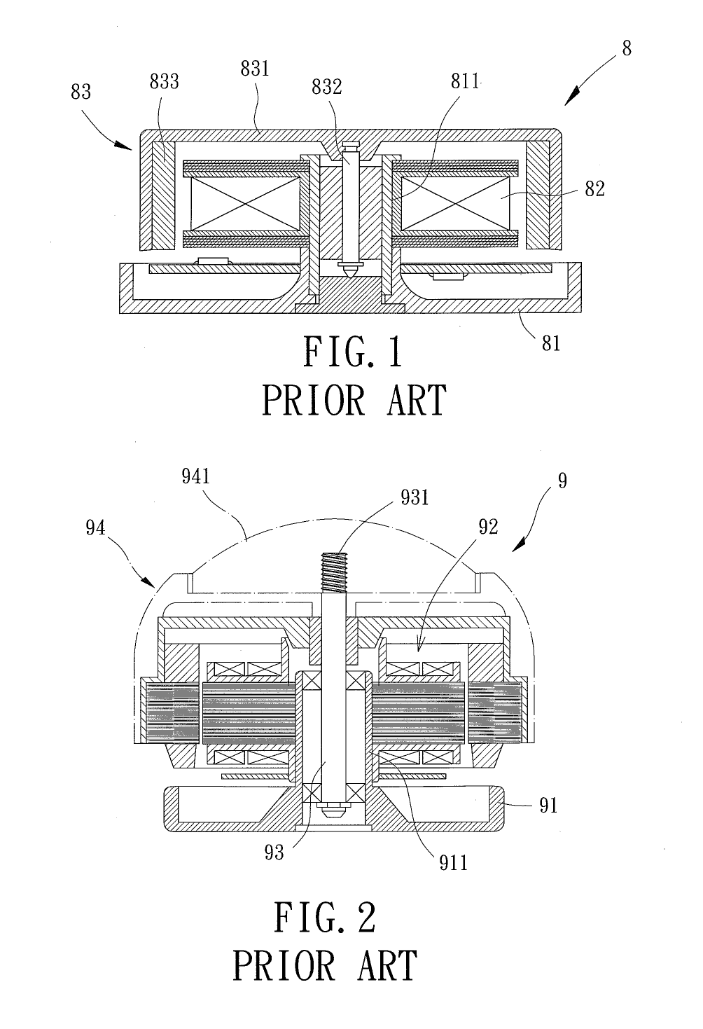

In the various figures of the drawings, the same numerals designate the same or similar parts. Furthermore, when the term “first,” “second,” “third,” “top,” “bottom,” “inner,” “outer,” and similar terms are used hereinafter, it should be understood that these terms are reference only to the structure shown in the drawings as it would appear to a person viewing the drawings and are utilized only to facilitate describing the invention.

### DETAILED DESCRIPTION OF THE INVENTION

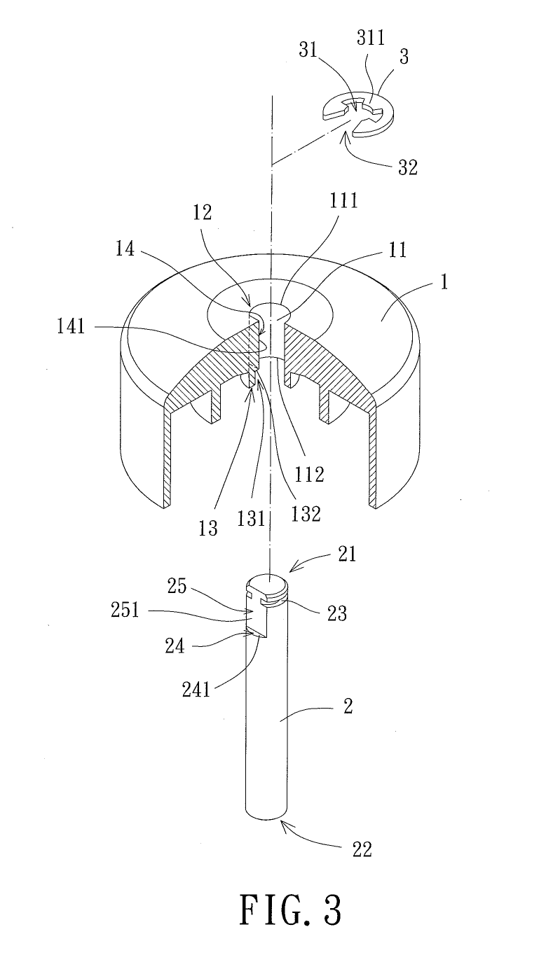

Referring FIGS. 3 through 5, a rotating part assembly for motor of the present invention includes a hub 1, a shaft 2, and a holding member 3. The hub 1 couples with the shaft 2 and the holding member 3 is mounted on an end of the shaft 2 to prevent the disengagement of the hub 1 from the shaft 2.

The hub 1 has an assembly channel 11 extending from an outer surface of the hub 1 to an inner surface of the hub 1, so that the assembly channel 11 has a first end 111 disposed at the outer surface of the hub 1 and a second end 112 disposed at the inner surface of the hub 1. Besides, a first abutting portion 12 of the outer surface of the hub 1 encircles and defines the first end 111 of the assembly channel 11. Similarly, a second abutting portion 13 of the inner surface of the hub 1 encircles and defines the second end 112 of the assembly channel 11. Furthermore, a lateral wall delimiting the assembly channel 11 has a first positioning portion 14 between the first end 111 and the second end 112.

The shaft 2 extends through the assembly channel 11, with the shaft 2 engaging with the lateral wall of the assembly channel 11 via a first end section 21 and extending out of the assembly channel 11 from the second end 112 to form a second end section 22. Specifically, the shaft 2 further has an engaging slit 23, an engaging shoulder 24, and a second positioning portion 25 at the first end section 21. When the shaft 2 is coupled with the hub 1, the engaging slit 23 is aligned with the first abutting portion 12 of the hub 1 in a radial direction of the shaft 2. The engaging shoulder 24 aligns with the second abutting portion 13. Preferably, the second positioning portion 25 is formed between the engaging slit 23 and engaging shoulder 24 and aligns and couples with the first positioning portion 14 of the hub 1, so as to provide an anti-rotation effect of the shaft 2 relative to the hub 1. Preferably, the hub 1 and the shaft 2 are combined in a close-fitting manner between the lateral wall of the assembly channel 11 and the first end section 21 of the shaft 2.

The holding member 3 inserts into and partially couples within the engaging slit 23 and abuts the first abutting portion 12 of the hub 1. Specifically, referring to FIG. 3, the holding member 3 has an axial hole 31 surrounded by an engaging edge 311, with the axial hole 31 allowing the shaft 2 to be passed therethrough, as well as the engaging edge 311 inserting into and coupling within the engaging slit 23 of the shaft 2. Accordingly, with the abutting relationship between the holding member 3 and the first abutting portion 12, the shaft 2 can be firmly fixed with the hub 1 without easily disengaging from the assembly channel 11.

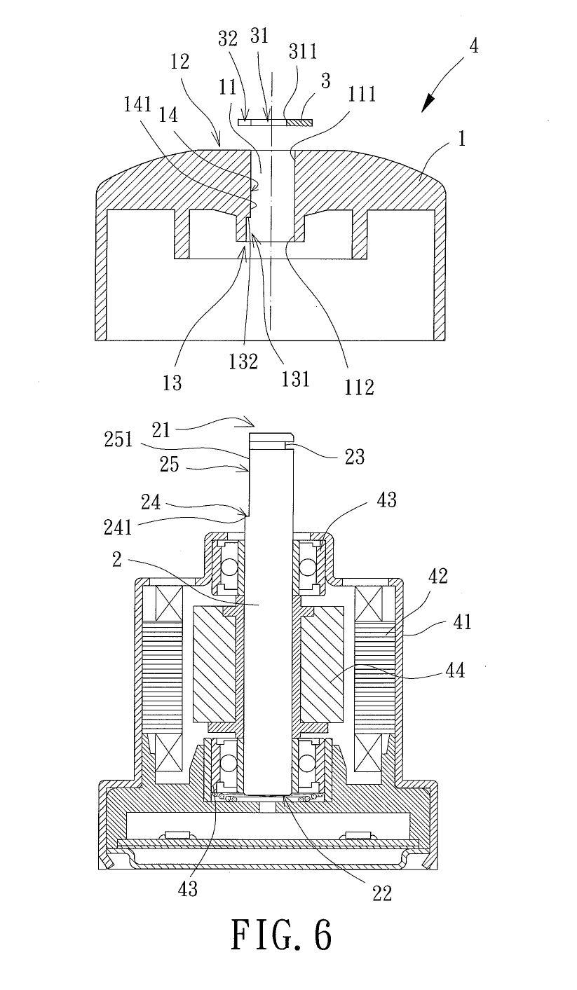

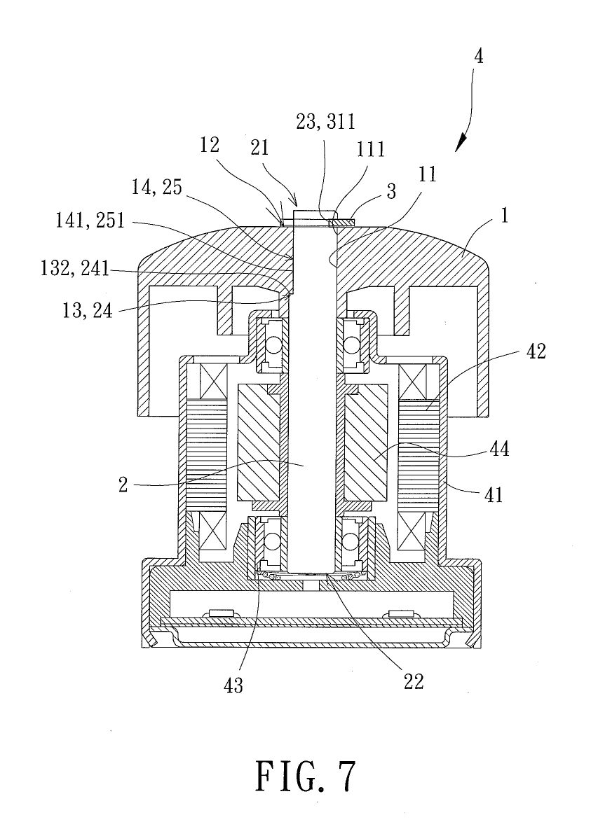

The rotating part assembly of the present invention is suitable for use in all kinds of motors, such as inner rotor motors or motors with the hubs and shafts separately shaped. Referring to FIG. 6, an inner rotor motor 4 including the rotating part assembly of the present invention is shown. In addition to the hub 1, shaft 2, and holding member 3, the inner rotor motor 4 further includes a casing 41, a stator 42, a plurality of bearings 43, and a permanent magnet 44. Typically, during assembly of the inner rotor motor 4, the hub 1 is usually mounted on the shaft 2 after the shaft 2 is assembled. Thus, the rotating part assembly of the present invention is especially suitable for every kind of inner rotor motors. In detail, the stator 42 and bearings 43 are firmly coupled within the casing 41. The permanent magnet 44 is circularly and radially mounted around the shaft 2, while an axially extending and cylinder-shaped air gap is formed between the permanent magnet 44 and the stator 42, so that the stator 42 may be electrified to trigger the rotation of the permanent magnet 44 and the shaft 2. Besides, the first end section 21 of the shaft 2 protrudes out of the casing 41 while the second end section 22 rotatably couples with the casing 41 through the bearings 43. Please further refer to FIG. 7. The hub 1 is mounted onto the first end section 21 of the shaft 2 and axially fixed between the engaging shoulder 24 and the holding member 3 after the casing 41, stator 42, bearings 43, permanent magnet 44, and shaft 2 are assembled. Accordingly, the following advantages can be provided through the proposed rotating part assembly.

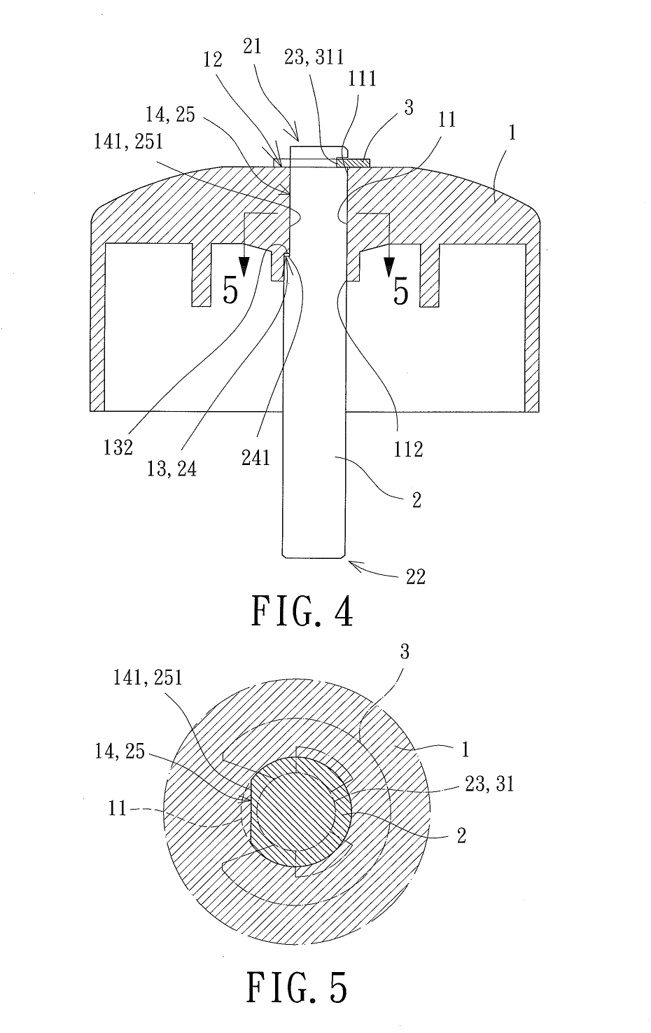

Firstly, a desired stability in assembly is provided. The hub 1 is positioned between the holding member 3 and the engaging shoulder 24, with the holding member 3 abutting the first abutting portion 12 and the engaging shoulder 24 aligning with the second abutting portion 13, as shown in FIG. 4. Therefore, the shaft 2 may not easily disengage from the assembly channel 11 of the hub 1 along the axial direction of the shaft 2. Furthermore, the second positioning portion 25 of the shaft 2 faces and abuts the first positioning portion 14 of the hub 1, so that the shaft 2 can not rotate relative to the hub 1. In other words, both axial cross-sections of the first end section 21 and the assembly channel 11, which are structurally complementary, are in a non-circular shape to prevent the hub 1 from rotating along a peripheral direction of the shaft 2. Consequently, with the structural design of the present invention, the shaft 2 can be firmly fixed in all the three dimensions relative to the hub 1. That is, the hub 1 is firmly mounted on the shaft 2 without relative rotation and movement.

Secondly, convenience in assembly is achieved. In detail, to firmly mount the hub 1 onto the first end section 21 of the shaft 2, only the following two steps are required during the assembly. The first step is inserting the first end section 21 of the shaft 2 through the assembly channel 11, allowing the engaging slit 23 to radially align with the first abutting portion 12. The second step is inserting the holding member 3 into the engaging slit 23. Accordingly, the assembly process becomes easy and simple, providing an improved efficiency in manufacturing the inner rotor motor 4.

Specifically, certain structural designs of the present invention are introduced below for a further improvement of the proposed rotating part assembly.

Firstly, as those shown in FIGS. 3 and 4, the first positioning portion 14 of the hub 1 has a rotation-limit surface 141. The rotation-limit surface 141 forms a part of the lateral wall of the assembly channel 11, faces the shaft 2, and axially extends from the first end 111 to the second end 112. The second positioning portion 25 correspondingly forms another rotation-limit surface 251 facing and abutting the said rotation-limit surface 141. Particularly, the rotation-limit surface 251 of the second positioning portion 25 axially extends a distance from a free end of the first end section 21 towards a root end of the rotation-limit surface 251, and said distance is larger than an axial length of the rotation-limit surface 141. In detail, based on the rotation-limit surface 251, the said root end is opposite to the free end of the first end section 21. Thereby, the anti-rotation effect is achieved through the abutting relationship between the two rotation-limit surfaces 141, 251.

Secondly, referring to FIGS. 3 and 4 again, a cavity 131 formed on the edge of the second end 112 of the assembly channel 11 serves as the second abutting portion 13 of the hub 1. Preferably, the cavity 131 is aligned with the first positioning portion 14 while the first positioning portion 14 defines a bottom surface 132 of the cavity 131. Specifically, the engaging shoulder 24 of the shaft 2 has a top surface 241 facing the cavity 131 and connecting with the root end of the rotation-limit surface 251. Accordingly, an adjusting gap (not numbered) between the bottom surface 132 and the top surface 241 is formed. Thus, the first abutting portion 12 can be easily aligned with the engaging slit 23 after the first end section 21 of the shaft 2 extends through the assembly channel 11 for the holding member 3 to directly insert into the engaging slit 23. Therefore, an easy assembly between the engaging slit 23 of the shaft 2 and the holding member 3 is provided.

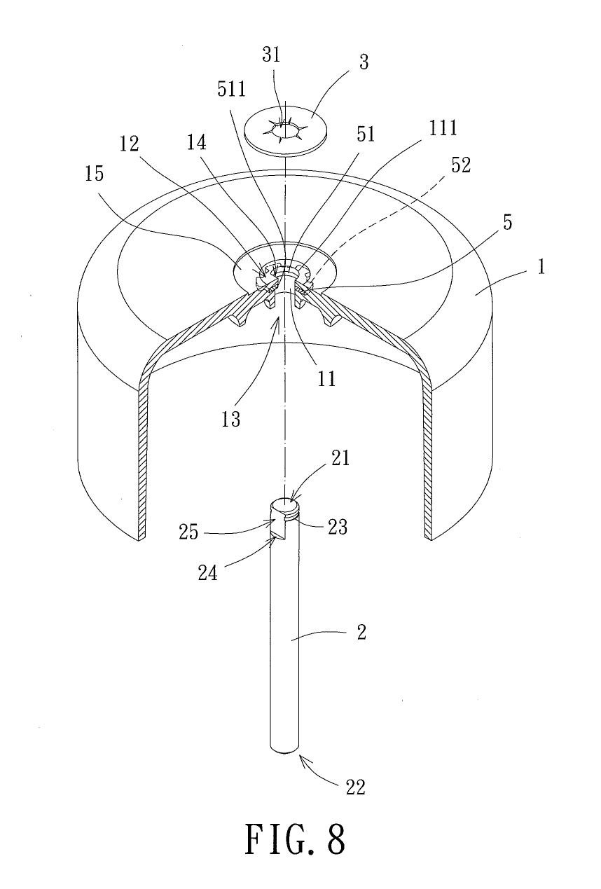

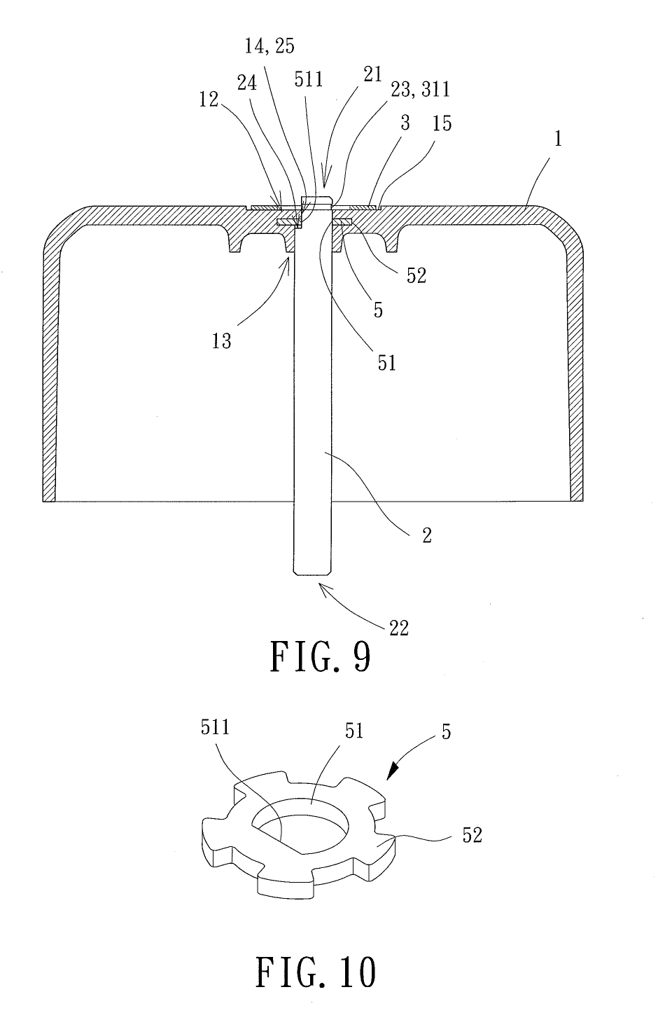

Thirdly, please refer to FIGS. 8 and 9 now. An enhancing member 5 of a material harder than that of the hub 1, such as steel, can be embedded in the hub 1. The enhancing member 5 forms a part of the lateral wall of the assembly channel 11 and is arranged between the first end 111 and the second end 112 of the assembly channel 11. Preferably, the hub 1 is coupled with an outer periphery of the enhancing member 5 in an integral injection manner, allowing the enhancing member 5 to be settled within the the hub 1. Specifically, the enhancing member 5 has a passageway 51 and surrounds the assembly channel 11 while the passageway 51 serves as a part of the assembly channel 11 for the shaft 2 to pass through. The enhancing member 5 can efficiently enhance the structural strength of a part of the hub 1 adjacent to the assembly channel 11 and thus prevent the deformation of the assembly channel 11 during the assembly of the hub 1, shaft 2, and holding member 3.

Fourthly, an auxiliary positioning portion 511 of the enhancing member 5, which forms a part of the periphery wall of the passageway 51, may also be provided as shown in FIGS. 8, 9, and 10. With this arrangement, the auxiliary positioning portion 511 can also face and couple with the second positioning portion 25 of the shaft 2. Thereby, the enhancing member 5 can also enhance the strength of the anti-rotation function, preventing the relative rotation between the shaft 2 and the hub 1.

Fifthly, please refer to FIGS. 8, 9, and 10 again. The outer periphery of the enhancing member 5 preferably forms a plurality of teeth 52. With these teeth 52, when the enhancing member 5 is embedded in the hub 1 that is simultaneously shaped by injection molding, the teeth 52 increases the connecting area between the hub 1 and the enhancing member 5, thereby enhancing the structural intensity of the hub 1.

Sixthly, referring to FIGS. 8 and 9 again, a depression 15 is formed around the first end 111 of the assembly channel 11 to receive the holding member 3, with the first abutting portion 12 serving as a bottom face of the depression 15. Therefore, the holding member 3 received inside the depression 15 does not increase the total axial length of the rotating part assembly, so as to efficiently maintain the size of a miniature fan using the present rotating part assembly.

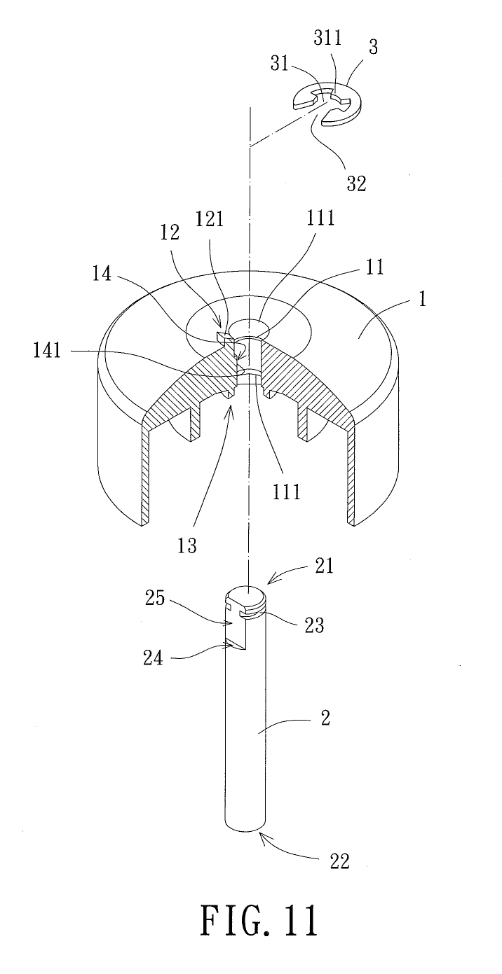

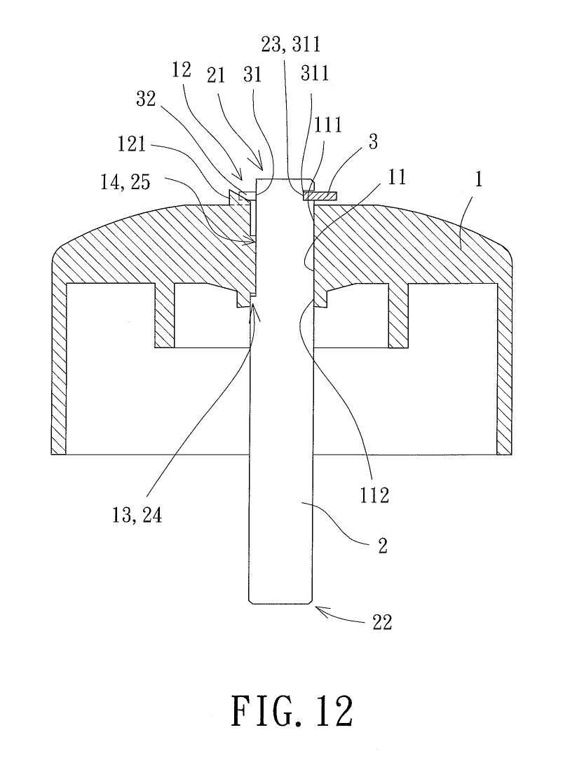

Seventhly, please refer to FIGS. 11 and 12 now. The holding member 3 is made of flexible material, and the engaging edge 311 is preferably formed with a plurality of flexible teeth. Accordingly, the holding member 3 can be easily coupled into the engaging slit 23 with less limitation in inserting direction; that is, the holding member 3 may be mounted onto the shaft 2 along the axial direction or a redial direction of the shaft 2. Besides, damage of the holding member 3 after insertion of the holding member 3 can be avoided due to the utilization of the flexible material while a close fitness between the shaft 2 and holding member 3 is provided.

Eighthly, an opening 32 of the holding member 3 radially communicates the outer periphery of the holding member 3 and the axial hole 31 can be further provided. Correspondingly, a protrusion 121 of the first abutting portion 12 is formed to couple with the opening 32, so that the holding member 3 can be firmly positioned when coupling with the engaging slit 23 of the shaft 2, and a relative rotation between the holding member 3 and the hub 1 is prevented.

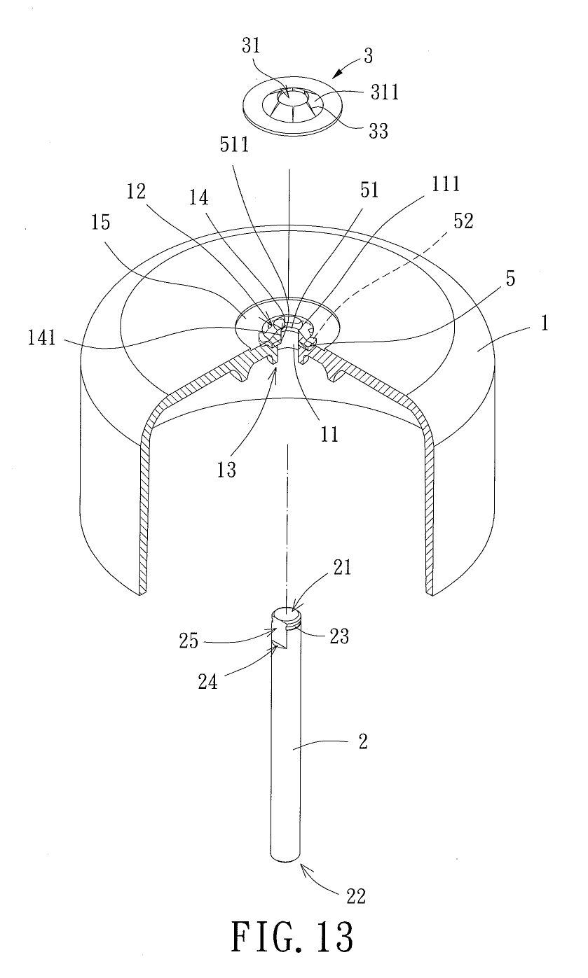

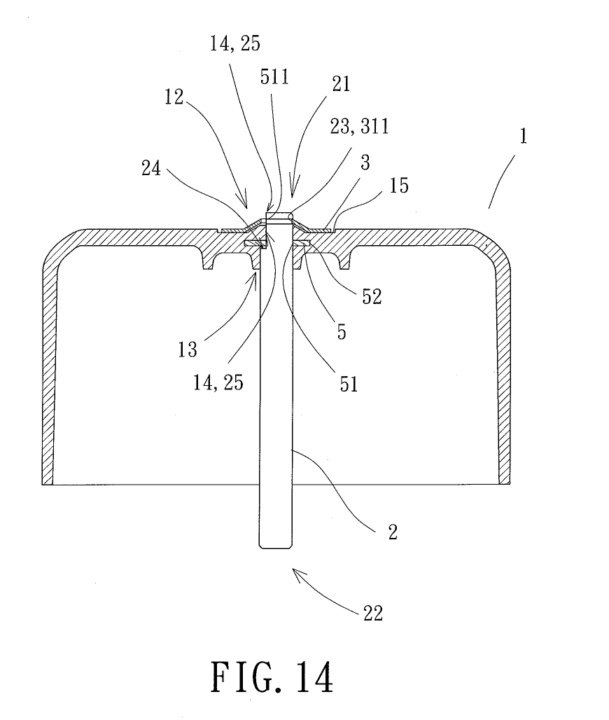

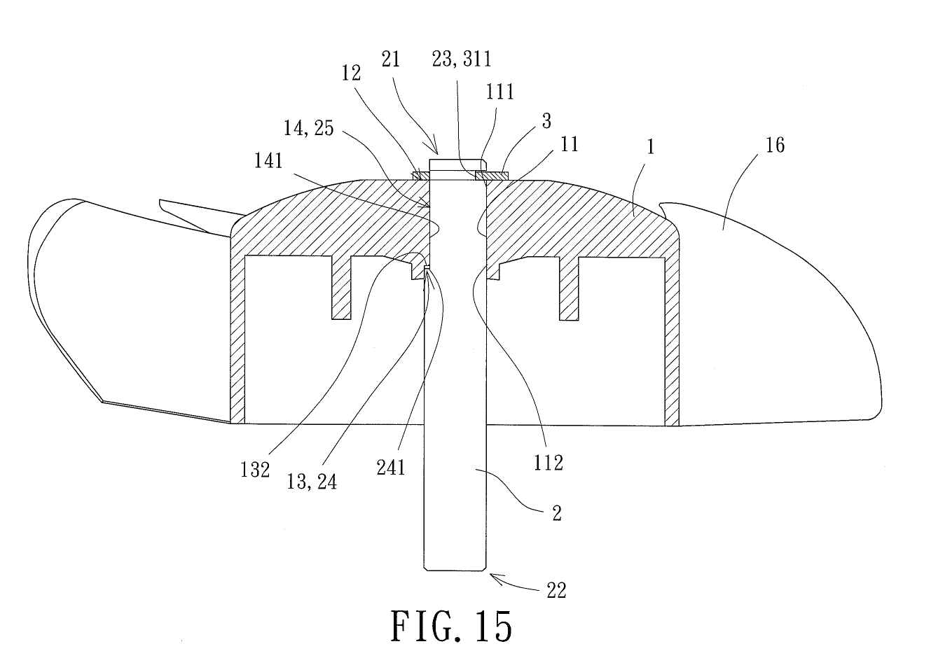

Ninthly, please refer to FIGS. 13 and 14. The holding member 3 can also be in another form with broaden teeth and from a plurality of radial slits 33, with any one of the radial slits 33 disposed between any adjacent two of the teeth while the opening 32 is absent. Besides, the teeth serving as the engaging edge 311 is preferably bent along a direction away from the hub 1 relative to a lower face of the holding member 3, wherein the lower face of the holding member 3 abuts the first abutting portion 12 of the hub 1. Accordingly, holding member 3 may not only radially extend into the engaging slit 23 with the engaging edge 311, but also provide an axial pressure upon the first abutting portion 12 through the lower face while the tips of the teeth abuts an upper axial wall of the engaging slit 23, so that an enhanced engagement performance between the holding member 3 and the shaft 2 is achieved.

Finally, a plurality of blades 16 can be integrally formed along a radial outer periphery of the hub 1 to serve as a fan wheel of a cooling fan.

As a result, with the hub 1 firmly fixed between the holding member 3 and the engaging shoulder 24 of the shaft 2 by the assembly channel 11 while the anti-rotation function is provided, the present rotating part assembly is structurally simple and easy for assembly.

Although the invention has been described in detail with reference to its presently preferred embodiment, it will be understood by one of ordinary skill in the art that various modifications can be made without departing from the spirit and the scope of the invention, as set forth in the appended claims.

What is claimed is:

1. A rotating part assembly for motor, comprising:
a hub having an assembly channel with a first end and a second end, with a first abutting portion encircling and defining the first end and a second abutting portion encircling and defining the second end, with a first positioning portion arranged between the first end and the second end of the assembly channel;
a shaft extending through the assembly channel of the hub, engaging with the assembly channel via a first end section, and extending out of the assembly channel from the second end to form a second end section, wherein an engaging slit aligning with the first abutting portion, an engaging shoulder aligning with the second abutting portion, and a second positioning portion facing the first positioning portion are disposed at the first end section; and
a holding member inserting into and coupling with the engaging slit and abutting the first abutting portion of the hub.

2. The rotating part assembly for motor as defined in claim 1, wherein an enhancing member is embedded in the hub and arranged between the first end and the second end of the assembly channel, with the enhancing member having a passageway for the shaft to pass through.

3. The rotating part assembly for motor as defined in claim 2, wherein an auxiliary positioning portion forms a part of a periphery wall of the passageway, and the auxiliary positioning portion faces and couples with the second positioning portion of the shaft.

4. The rotating part assembly for motor as defined in claim 2, wherein the hub couples with the auxiliary positioning portion by injection molding.

5. The rotating part assembly for motor as defined in claim 3, wherein an outer periphery of the enhancing member forms a plurality of teeth.

6. The rotating part assembly for motor as defined in claim 1, wherein the first positioning portion of the hub has a rotation-limit surface facing the shaft and axially extending from the first end to the second end, and the second positioning portion forms another rotation-limit surface facing the said rotation-limit surface of the first positioning portion.

7. The rotating part assembly for motor as defined in claim 6, wherein the two rotation-limit surfaces abut with each other.

8. The rotating part assembly for motor as defined in claim 6, wherein the second abutting portion of the hub is a cavity formed on an edge of the second end of the assembly channel, and the engaging shoulder of the shaft has a top surface connecting with the rotation-limit surface of the second positioning portion and facing the cavity.

9. The rotating part assembly for motor as defined in claim 8, wherein an adjusting gap is form between a bottom surface of the cavity and the top surface of the engaging shoulder.

10. The rotating part assembly for motor as defined in claim 1, wherein the holding member has an opening while the first abutting portion has a protrusion coupling with the opening of the holding member.

11. The rotating part assembly for motor as defined in claim 7, wherein the holding member has an axial hole defined by an engaging edge, and the engaging edge has a plurality of flexible teeth bent along a direction away from the hub, with the flexible teeth extending into the engaging slit and tips of the teeth abutting a wall of the engaging slit.

12. The rotating part assembly for motor as defined in claim 9, wherein the holding member has an axial hole defined by an engaging edge, and the engaging edge has a plurality of flexible teeth bent along a direction away from the hub, with the flexible teeth extending into the engaging slit and tips of the teeth abutting a wall of the engaging slit.

13. The rotating part assembly for motor as defined in claim 10, wherein the holding member has an axial hole defined by an engaging edge, and the engaging edge has a plurality of flexible teeth bent along a direction away from the hub, with the flexible teeth extending into the engaging slit and tips of the teeth abutting a wall of the engaging slit.

14. The rotating part assembly for motor as defined in claim 1, wherein the holding member has an axial hole defined by an engaging edge, and the engaging edge has a plurality of flexible teeth extending into the engaging slit, with a radial slit being disposed between any adjacent two of the flexible teeth.

15. The rotating part assembly for motor as defined in claim 1, wherein a depression is formed around the first end of the assembly channel and receives the holding member.

16. The rotating part assembly for motor as defined in claim 1, wherein a plurality of blades are formed along a radial outer periphery of the hub.
